(19) United States
(12) Patent Application Publication
(10) Pub. No.: US 2010/0041334 A1
(43) Pub. Date: Feb. 18, 2010

(54) DISCOVERING PRESENCE INFORMATION AND DISPLAYING A PRESENCE MAP

(75) Inventors: Jonathan R. Engelsma, Hudsonville, MI (US); John R. Barr, Deer Park, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/190,924

(22) Filed: Aug. 13, 2008

(51) Int. Cl. H04B 7/00

(52) U.S. Cl. 455/41.2

(57) ABSTRACT

Disclosed is a personal communication device (called here the “local device”) that “looks around” to discover the presence of other personal communication devices (“remote devices”) in the near neighborhood. Using various techniques, the local device attempts to discover who is associated with each remote device that it discovers. The local device also attempts to assign a position value to each discovered remote device. Using this information, the local device constructs a “presence map” for its user, the map showing who is nearby. By consulting the presence map, the user of the local device can associate a name with each person in the near neighborhood. In some embodiments, the presence map is a virtual two- or three-dimensional representation of the neighborhood surrounding the user of the local device.

### FIELD OF THE INVENTION

The present invention is related generally to personal communications devices, and, more particularly, to discovering and displaying presence information associated with such devices.

### BACKGROUND OF THE INVENTION

A person often finds himself in a social or business setting where he does not know the names of the people around him. He might not even remember the name of someone to whom he has just been introduced. Sometimes, he recognizes that a face is familiar to him, but, not having met that person in some time, he cannot associate a name with that face.

A person forgetting names in such a situation is at least uncomfortable. Unconsciously, he may make matters even worse by avoiding potentially embarrassing contact with the people whose names he “should” know. If the avoidance is perceived, the avoided person may feel slighted or insulted. Whether in a purely social or in a business environment, a failure to match a name to a face degrades the situation and may thwart the development of a mutually beneficial relationship.

### BRIEF SUMMARY

The above considerations, and others, are addressed by the present invention, which can be understood by referring to the specification, drawings, and claims. According to aspects of the present invention, a personal communication device (called here the “local device”) “looks around” to discover the presence of other personal communication devices (“remote devices”) in the near neighborhood. Using various techniques, the local device attempts to discover who is associated with each remote device that it discovers. The local device also attempts to assign a position value to each discovered remote device. Using this information, the local device constructs a “presence map” for its user, the map showing who is nearby. By consulting the presence map, the user of the local device can associate a name with each person in the near neighborhood.

In embodiments of the present invention, various techniques are used to associate contact information with a discovered remote device. The local device may consult a locally stored list of contacts, it may query the discovered remote device for contact information, and it may query a remote server. An interface is provided in some embodiments whereby the user of the local device can enter contact information directly. (For example, the user hears that a person is addressed as “Bob.” The user then tells his local device to label that person as “Bob” on the presence map.) If no contact information is available for a given remote device, then that device's owner can be labeled on the presence map as “?” or “unknown,” for example.

The location of a discovered remote device can be found by applying techniques such as radio ranging (e.g., based on signal strength or packet loss), indoor-positioning technology, or by triangulation based on cooperation among the local and remote devices. The location assigned may be in three-dimensional or two-dimensional space. In some situations, the location is one-dimensional, that is, the location consists solely of the distance from the local device to the remote device because the local device cannot determine the direction to the remote device.

In some embodiments, the presence map is a virtual two- or three-dimensional representation of the neighborhood surrounding the user of the local device. In some situations, the map may simply list the remote users in the order of distance from the local device. Other presence maps are useful in some situations, depending upon the amount of presence information available to the local device.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representative environment in which aspects of the present invention can be practiced;

FIGS. 2a and 2b are simplified schematic views of an exemplary personal portable device operating in the environment of FIG. 1;

FIG. 3 is a flowchart of an exemplary embodiment of the present invention; and

FIGS. 4a and 4b are exemplary presence maps produced according to aspects of the present invention.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

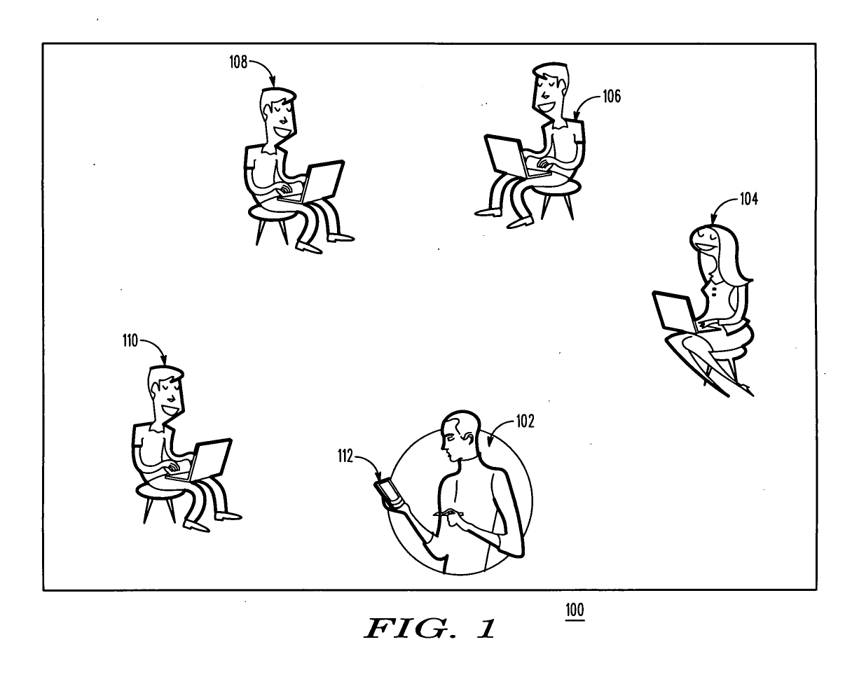

In the representative environment 100 of FIG. 1, the “local” user 102 is in a meeting with “remote” colleagues 104, 106, 108, and 110. In this discussion, “local” is simply a shorthand way for referring to the user, and to his personal portable device 112, that embodies aspects of the present invention. “Remote” is shorthand for the other people, and for their devices, in the setting with the local user 102. In most situations, the local and remote users will all be within a short distance (e.g., ten or so yards) of one another.

In order to interact easily, the local user 102 would like to know the names (or nicknames) of the remote users 104, . . . , 110. The local user 102 may remember some of their names, but he relies on aspects of the present invention to discover and to present to him the other names.

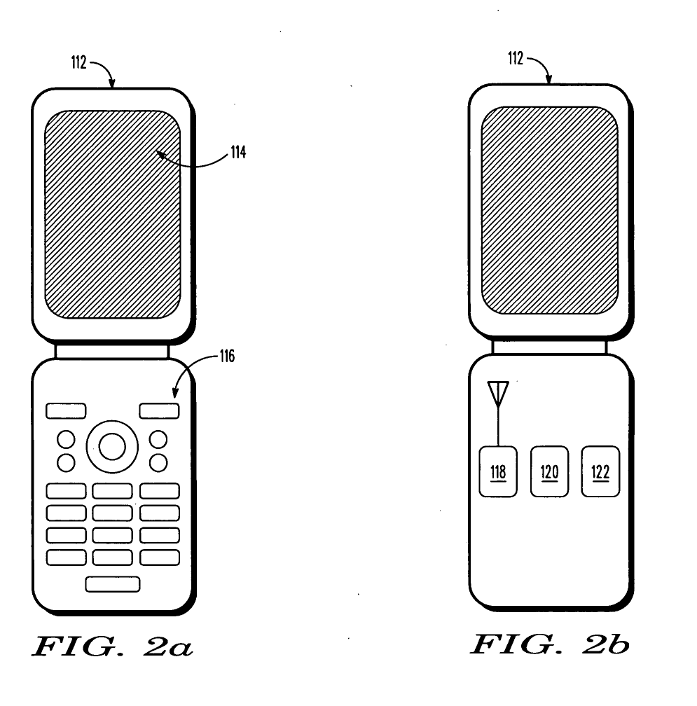

Name discovery and presentation methods are embodied in a device such as the local user's personal portable device 112 as shown in FIGS. 2a and 2b. The device 112 is, for example, a cell phone or personal digital assistant and includes a user interface with a display screen 114 and a keypad 116 or other user-input device. The device includes a communications system 118, a processor 120, and a memory 122.

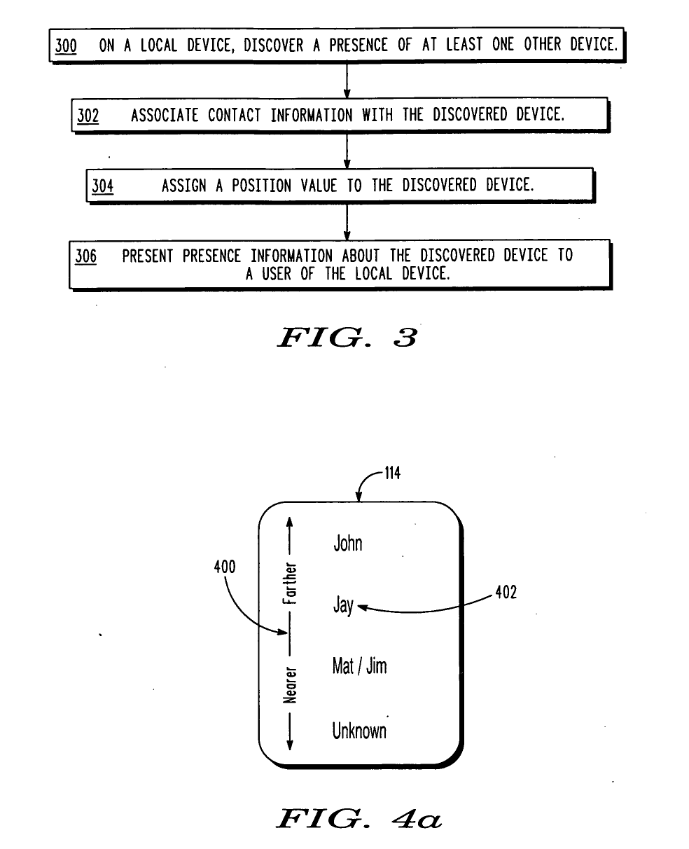

In an exemplary method of the present invention shown in FIG. 3, the communications system 118 of the personal portable device 112 begins by discovering the presence of other nearby devices (step 300). Several techniques can be used separately or in conjunction here. For example, the communications system 118 can include PAN (“personal area network”) technology (e.g., Bluetooth or ultra-wideband radio). The device 112 can listen passively for communications of other nearby devices. Some technologies allow the device 112 to post a “Who is there?” query, and the other devices can respond by identifying themselves. In some cases, the query can be passed along, and each recipient device can respond not only with its own identification but also with the identifications of other devices it has discovered. By cooperating, the devices in a small restricted range can together ensure that every device is eventually discovered.

Note that the distance from the local device 112 to a particular remote device is important. While this aspect is examined in greater detail below (in reference to step 304 of FIG. 3), it is worth pointing out here that some PAN technologies inherently include some distance information. In particular, only those devices within a certain distance from the local device 112 can be detected. In many applications of the present invention, this distance limitation is clearly an advantage. The local user 102 wants to know who is in the meeting with him; he is not interested in discovering every device within a city. Even in a large meeting room, the inherent distance limitation may enable the local device 112 to detect only those devices within its immediate vicinity rather than the possibly hundreds of devices located throughout the large room. Here, the local user 102 is probably more interested in the names of those people nearest to him and does not need the names of everyone in the room. Again, the inherent distance limitation is not a deficiency but a benefit reducing information overload.

In any event, upon completing step 300 of FIG. 3, the local device 112 has a list of other devices within a certain distance from itself. At this point, however, the local device 112 knows each of these other devices by its device identification or by its communications address rather than by the name of a human being associated with it. In step 302, the local device 112 attempts to find human names for each device that it discovered in step 300. In many embodiments, the local device 112 uses multiple techniques at this stage. The local device 112 may begin by querying a contact list stored in its own memory 122. The contact list associates an address of a remote device with a user of that device.

Of course, the usefulness of the contact list stored on the local device 112 is limited to those entries already in it. To help the local user 102 with names not in his contact list, the local device 112 can query the remote devices it has discovered, asking them for their contact information. The local device 112 may also query a remote server, such as a telephone directory server, for this information. In some situations, the local user 102 can provide the contact information. For example, the local user 102 may overhear one of the remote users referring to another remote user as “Bob.” The local user 102 can then, via the user interface 114, 116 of the local device 112, assign the contact information “Bob” to the appropriate discovered device. For some meetings, an electronic list of invitees is made available to the local user 102 (e.g., via an invitation e-mail) and may be consulted when assigning contact information.

Sometimes, all attempts to assign contact information may fail. This possibility is considered in the discussion, below, of the presence map.

In addition to attempting to assign contact information to each discovered device, the local device 112 in some embodiments attempts to assign a position value to each discovered device (step 304 of FIG. 3). Once again, many techniques may be used here. Often the techniques used in a given situation are determined by the capabilities embodied in the local device 112.

As one aspect of position, the local device 112 can attempt to determine a distance from itself to a discovered remote device. As mentioned above, some discovery techniques have an inherent distance limitation, recognizing, for example, only devices within ten yards of the local device 112. For more precision, the local device 112 can monitor the transmissions of the remote device and the communications between the remote device and itself. For example, round-trip transmission times increase with increasing distance. Signal strength decreases with increasing range. The ratio of packets lost increases with increasing range. Other aspects of the radio transmissions may be examined to estimate the range, with varying degrees of precision.

In some embodiments, the local device 112 and a discovered device may each know its own position rather accurately (e.g., they may each include highly accurate indoor-positioning technology). The local device 112 may then be able to simply query the remote device for its position and then calculate the distance between the devices.

To find the position of each discovered device, the local device 112 in some embodiments determines the direction from the local device 112 toward each discovered device. With the direction and the distance, the local device 112 can place the discovered device in two-dimensional space, relative to the local device 112. In some embodiments, the local device 112 uses a direction finder connected to the communications system 118 to locate a discovered remote device. In other embodiments, the local device 112 cooperates with remote devices to discover direction. For example, once the devices all know their distances from one to another, simple geometry is applied to map their respective locations. In some situations, unfortunately, the respective distances do not provide enough information to produce a unique location map. Possible solutions to this problem are addressed below in the discussion of the interactive presence map.

In the embodiments where each device knows its own location (as discussed above), it is straightforward for them to share this information for use in mapping.

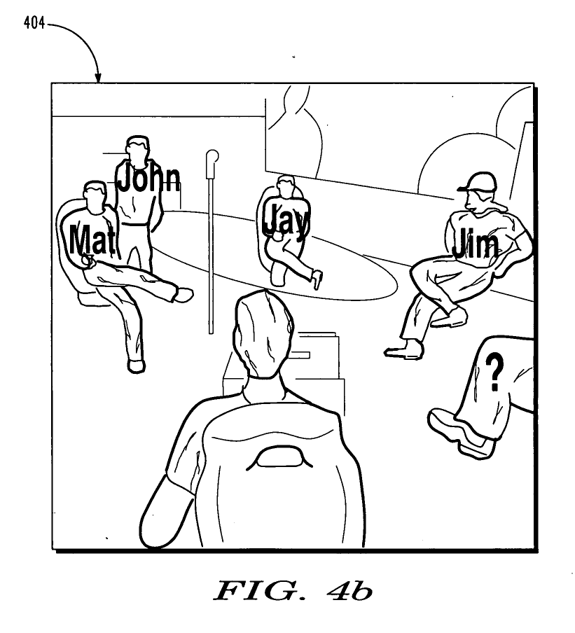

Having attempted to associate contact information and position information with each discovered device, the local device 112 creates a “presence map” with this information and presents the map to the local user 102 (step 306 of FIG. 3). Various embodiments of the presence map are possible, the use of each depending upon the amount and quality of information available to the local device 112 when making the map. As a first example, FIG. 4a shows a simple presence map on the display 114 of the local device 112. In this example, the local device 112 discovered five remote devices and was able to assign contact information (402) to four of them. The fifth is labeled “unknown.” The presence map of FIG. 4a roughly indicates the distance (400) to each discovered device from the local device 112. (Mat and Jim are approximately the same distance from the local device 112.) However, this example gives no direction information for the discovered devices, possibly because the local device 112 could not discover that information.

In FIG. 4b, the same discovered devices of FIG. 4a are shown in a richer presence map 404. In making this presence map 404, the local device 112 was able to assign position information to each discovered device showing, for example, Mat over on the left and the unknown person nearby on the right. This is really a two-dimensional map (distance and direction) made to look three-dimensional for the benefit of the local user 102. The picture of the room displayed in the map 404 may be completely arbitrary or may be based on the actual room where the meeting is taking place. Note that the map 404 is presented from the point of view of the local user 102. If each user in the meeting is using aspects of the present invention to prepare a presence map, then each map could be shown from the point of view of that user.

Using either the linear presence map of FIG. 4a or the multi-dimensional map 404 of FIG. 4b, the local user 102 can use his user interface 114, 116 to assign contact information to the unknown person. For example, if John addresses this unknown person as “Bob,” the local user 102 may select the unknown user icon on the presence map and enter the name “Bob.” The map then helps the local user 102 to remember this new name. Of course, the same technique can be used to reassign contact information in the situation where one person borrows an electronic device normally associated with another, and the local device 102 understandably but mistakenly presents the owner as the contact rather than the borrower.

The local user 102 may use the interface 114, 116 to move icons around. For example, the local device 112 discovers that Mat and Jim are about the same distance away but, not being able to determine direction, randomly and mistakenly assigns Mat to the right of the map and Jim to the left. The local user 102 (perhaps hearing the person on his right addressed as “Jim”) switches the icons to their correct locations. As this example illustrates, the presence map 404 may be imperfect in some situations, but it is still a useful memory tool for the local user 102.

Various refinements to the presence map are useful in some situations. A maximum distance can be imposed, and devices discovered beyond that distance are simply not shown to avoid cluttering the display with people the local user 102 is not now in contact with. The local user 102 may select one of the people from the presence map and pull up information about that person, either from the local device 102 or from a remote server. This extension turns the presence map into a virtual “farley file” (a list used by politicians containing details of previous contacts with each of the thousands of people the politician has met and is expected to remember). If a photograph of one of the meeting participants is available, then the icon representing that person can be made more realistic than the generic icons of FIG. 4b.

Consider the situation where one of the people in the meeting is not carrying an electronically discoverable device. As presented so far, this person would not show up in the presence map at all. In some embodiments, the local user can add an entry to the automatically produced presence map, give the new entry an appropriate position on the presence map, and assign contact information when known.

In view of the many possible embodiments to which the principles of the present invention may be applied, it should be recognized that the embodiments described herein with respect to the drawing figures are meant to be illustrative only and should not be taken as limiting the scope of the invention. For example, numerous radio communications technologies, of varying range, are known and may be useful in various situations. Other embodiments of the presence map may be useful, showing various types of information, depending upon the information available and on the size of the available display. Therefore, the invention as described herein contemplates all such embodiments as may come within the scope of the following claims and equivalents thereof.

We claim:

1. On a local device, a method for gathering and presenting presence information, the method comprising:
discovering a presence of at least one other device;
attempting to associate contact information with the discovered device;
assigning a position value to the discovered device; and
presenting presence information for the discovered device, the presenting based, at least in part, on contact information associated with the discovered device, if any, and on the position value assigned to the discovered device.

2. The method of claim 1 wherein discovering a presence comprises evaluating radio transmissions among other devices.

3. The method of claim 1 wherein discovering a presence comprises querying another device for presence information regarding yet other devices.

4. The method of claim 1 wherein attempting to associate contact information comprises accessing information in a manner selected from the group consisting of: accessing contact information stored on the local device, requesting contact information from a remote device, querying the discovered device for contact information, and receiving contact information from a user of the local device.

5. The method of claim 1 wherein assigning a position value comprises assigning a value selected from the group consisting of: an estimated distance from the local device to the discovered device, a direction from the local device to the discovered device, a position of the discovered device in two-dimensional space, a position of the discovered device in three-dimensional space, and a binary value representing a presence or absence of the discovered device.

6. The method of claim 1 wherein assigning a position value comprises using a value selected from the group consisting of: a packet-loss ratio for the discovered device, a signal strength value for the discovered device, and a property associated with a radio transmission process of the discovered device.

7. The method of claim 1 wherein assigning a position value comprises querying another device for position information.

8. The method of claim 1 wherein presenting presence information comprises presenting a two-dimensional map indicating a position of the discovered device with respect to the local device.

9. The method of claim 1 further comprising:
if attempting to associate contact information with the discovered device fails, then presenting the discovered device as anonymous.

10. The method of claim 1 further comprising:
only presenting presence information if the discovered device is within a certain range of the local device.

11. On a local device, a method for presenting, on a user interface of the local device, presence information for at least one other device, the method comprising:
presenting contact information associated with the other device; and
presenting position information associated with the other device.

12. The method of claim 11 wherein presenting contact information associated with the other device comprises presenting the device as anonymous if no other contact information is available.

13. The method of claim 11 wherein presenting position information is based, at least in part, on an element selected from the group consisting of: an estimated distance from the local device to the other device, a direction from the local device to the other device, a position of the other device in two-dimensional space, a position of the other device in three-dimensional space, and a binary value representing a presence or absence of the other device.

14. The method of claim 11 wherein presenting presence information comprises presenting a two-dimensional map indicating a position of the other device with respect to the local device.

15. The method of claim 11 further comprising:
only presenting presence information if the other device is within a certain range of the local device.

16. The method of claim 11 further comprising:
receiving input from a user of the local device, the input comprising contact information associated with the other device.

17. A personal portable device comprising:
a communications system configured for discovering a presence of at least one other device;
a processing system configured for attempting to associate contact information with the discovered device and for assigning a position value to the discovered device; and
a user interface configured for displaying contact information associated with the other device and for displaying position information associated with the other device.

18. The personal portable device of claim 17 wherein the device is selected from the group consisting of: a cellular telephone, a personal digital assistant, and a personal computer.

19. The personal portable device of claim 17 wherein the user interface is further configured for receiving input from a user of the local device, the input comprising contact information associated with the other device.

20. The personal portable device of claim 17 further comprising:
a memory configured for storing contact information of another device.
